(19) United States
(12) Patent Application Publication
(10) Pub. No.: US 2009/0141303 A1
(43) Pub. Date: Jun. 4, 2009

(54) PRINTING SYSTEM AND PRINTER SPECIFYING METHOD

(75) Inventor: Juntaro Azuchi, Atsugi-shi (JP)

Correspondence Address: SIDLEY AUSTIN LLP, 717 NORTH HARWOOD, SUITE 3400, DALLAS, TX, 75201, US

(73) Assignee: Konica Minolta Business Technologies, Inc., Tokyo (JP)

(21) Appl. No.: 12/126,160

(22) Filed: May 23, 2008

(30) Foreign Application Priority Data
Nov. 29, 2007 (JP) 2007-308847

(51) Int. Cl. G06K 15/00

(52) U.S. Cl. 358/1.15

(57) ABSTRACT

There is described a printing system, which includes a plurality of printers and a user terminal device, while makes it possible to easily and securely specify a printer desired by the user. The user terminal device is provided with: a command transmitting section that transmits the printer retrieving command to the plurality of printers; a command judging section that determines whether or not specific information is attached to the printer-retrieving command response; and a display controlling section to display the specific printer in a recognizable manner on a printer selecting screen. Each printer is provided with: a command processing section that determines whether or not the user information added to the printer retrieving command coincides with the other user information inputted and stored in advance; and a command responding section that transmits the printer-retrieving command response to the user terminal device, when the two user information coincide with each other.

This application is based on Japanese Patent Application No. 2007-308847 filed on Nov. 29, 2007, with Japan Patent Office, the entire content of which is hereby incorporated by reference.

### BACKGROUND OF THE INVENTION

The present invention relates to a printing system and a printer specifying method.

In a certain company or the like, a plurality of printers are coupled to a communication network, so that the user can activates an arbitral printer to acquire printouts. In this kind of system, the user executes a printer driver installed in a terminal device currently employed by the user (hereinafter, referred to as a user terminal device, for simplicity), so as to retrieve currently available printers, and makes the user terminal device display a list of the retrieved available printers, so as to select a specific printer having a desired name form the list, and makes the selected printer implement the printing operation.

In this connection, since each name of the printers tends to be indicated by using its type number, or the like, it has been difficult for the user to specify a desired printer form a lot of printers. Specifically, when the user wishes to use one of printers installed into the place where the user has gone or the public place, since the user cannot recognize what names are attached to the printers concerned and what kind of sites such the printers are installed into, it has become further difficult for the user to specify the desired printer, resulting in such an error that the printouts are outputted form a printer unintended by the user.

To overcome the abovementioned problem, as shown in FIG. 18, Tokkai 2006-236176 (Japanese Non-Examined Patent Publication) sets forth such a system configuration that, when the user inputs a retrieving command into the user terminal device, printers residing within a visible and audible range of the user in the vicinity of the user terminal device are retrieved by employing the near distance radio communication chip “Bluetooth”, so as to create the list of designation candidate printers, and, when the user transmits the signals called “connect signals” to the designation candidate printers indicated in the list one by one, each of the designation candidate printers, which receives corresponding one of the connect signals, turns ON the light emitting section or outputs audible voice.

In the abovementioned system configuration set forth by Tokkai 2006-236176, however, since the system is established on the premise that the concerned printers reside within the visible and audible range of the user, for instance, in such the case that the concerned printers are disposed at positions which are invisible by the user, or in such the case that the sound emitted by each of the printers is inaudible for the user due to a masking effect of the environmental noise, there has arisen a problem that it is impossible for the user to specify the desired printer.

Further, in the abovementioned system, set forth by Tokkai 2006-236176, in which the connect signals are sequentially transmitted to the printers one by one, since it is necessary to put a predetermined time interval between one transmission and next transmission of the connect signals, so that the user can recognize the light emitted from the light emitting section or the sound emission of each of the printers. Accordingly, when many printers are installed in the system, there has been a problem that it takes much time for the user to specify the specific printer that the user currently whishes to use.

Still further, if the user erroneously heard the sound or erroneously recognized the light emitted from the light emitting section, a certain unexpected printer would make the printouts for the user concerned. As a result, specifically in such the case that the printouts are a print product including secret information, there has arisen a problem that a risk of leaking the secret information would increase since the print product would be possibly left on the unexpected printer for long time as it is.

### SUMMARY OF THE INVENTION

To overcome the abovementioned drawbacks in conventional printing systems, it is one of objects of the present invention to provide a printing system and a printer specifying method, each of which makes it possible to easily and securely specify a printer desired by the user, even under such an environment in which a plurality of printers are coupled to each other through a network.

Accordingly, at least one of the objects of the present invention can be attained by one of the printing systems described as follows.

(1) According to a printing system reflecting an aspect of the present invention, the printing system comprises: a plurality of printers to implement a printing operation; and a user terminal device, coupled to the plurality of printers through a communication network, to instruct at least one of the plurality of printers to implement the printing operation; wherein the user terminal device is provided with: a command transmitting section that creates a command to which user information is added, the command being for retrieving printers, and transmits the command to the plurality of printers through the communication network; a command judging section that receives responses to the command sent back from the plurality of printers, and determines whether or not specific information is attached to each of the responses; and a display controlling section that controls a display section to display on a printer selecting screen only the specific printer that transmits the response to which the specific information is attached, or to display on the printer selecting screen all of the plurality of printers that sent back the responses among which the specific printer is recognizable; and wherein each of the plurality of printers is provided with: an instruction button; a command processing section that receives the command sent from the user terminal device, and determines whether or not the user information added to the command coincides with user information stored in advance, when the instruction button is depressed; and a command responding section that creates the response by attaching the specific information to the response to the printer retrieving command, and transmits the response to the user terminal device, when the command processing section determines that the user information added to the command coincides with the stored user information.
(2) According to another aspect of the present invention, in the printing system recited in item 1, when the command judging section of the user terminal device determines that none of the plurality of printers sent back the response to which the specific information is attached, the display controlling section controls the display section to display all of printers that sent back the responses.
(3) According to a printing system reflecting another aspect of the present invention, the printing system comprises: a plurality of printers to implement a printing operation; and a user terminal device, coupled to the plurality of printers through a communication network, to instruct at least one of the plurality of printers to implement the printing operation; wherein the user terminal device is provided with: a command transmitting section that creates a command to which user information is added, and transmits the command to the plurality of printers through the communication network, wherein the command is for retrieving a specific printer among the plurality of printers; a command judging section that receives a response to the command sent back from one of the plurality of printers; and a display controlling section that controls a display section to display on a printer selection screen only the specific printer that transmits the response; and wherein each of the plurality of printers is provided with: an instruction button; a command processing section that receives the command sent from the user terminal device, and determines whether or not the user information added to the printer retrieving command coincides with user information stored in advance, when the instruction button is depressed; and a command responding section that transmits the response to the user terminal device, only when the command processing section determines that the user information added to the command coincides with the stored user information.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram of a configuration of a printing system embodied in the present invention as the first embodiment;

FIG. 2 shows a block diagram indicating a configuration of a printer embodied in the present invention as the first embodiment;

FIG. 3 shows a configuration of software of the printer embodied in the present invention as the first embodiment;

FIG. 4 shows a block diagram indicating a configuration of the user terminal device embodied in the present invention as the first embodiment;

FIG. 5 shows a configuration of software (printer driver) of the user terminal device embodied in the present invention as the first embodiment;

FIG. 6 shows a schematic diagram briefly indicating operations of a printing system embodied in the present invention as the first embodiment;

FIG. 7 shows a schematic diagram indicating an operational flow of a printing system as a whole, embodied in the present invention as the first embodiment;

FIG. 8 shows a flowchart indicating detailed operations to be conducted in a user terminal device embodied in the present invention as the first embodiment;

FIG. 9 shows a flowchart indicating detailed operations to be conducted in a printer embodied in the present invention as the first embodiment;

FIG. 10 shows an exemplary layout of a user information inputting screen to be displayed on a printer embodied in the present invention as the first embodiment;

FIG. 11 shows an exemplary layout of a software keyboard screen to be displayed on a printer embodied in the present invention as the first embodiment;

FIG. 12 show an exemplary structure of a printer retrieving command to be employed in a printing system embodied in the present invention as the first embodiment;

FIG. 13 show an exemplary structure of a printer retrieving command response to be employed in a printing system embodied in the present invention as the first embodiment;

FIG. 14(a) and FIG. 14(b) show exemplary layouts of a printer selecting screen to be displayed on a user terminal device embodied in the present invention as the first embodiment;

FIG. 15 shows a schematic diagram indicating an operational flow of a printing system as a whole, embodied in the present invention as the second embodiment;

FIG. 16 shows a flowchart indicating detailed operations to be conducted in a user terminal device embodied in the present invention as the second embodiment;

FIG. 17 shows a flowchart indicating detailed operations to be conducted in a printer embodied in the present invention as the second embodiment; and

FIG. 18 shows a schematic diagram briefly indicating operations of a conventional printing system.

### DETAILED DESCRIPTION OF THE PREFERRED EMBODIMENT

The printing system, embodied in the present invention as the preferred embodiment, includes at least a user terminal device that instructs a printing operation and a plurality of printers that implement the printing operation.

Each of the plurality of printers is provided with: a printer specifying button to establish an ON/OFF (activation or deactivation) state of a printer specifying function; a command processing section to receive and parse a printer retrieving command sent from the user terminal device, so as to determine whether or not user information included in the printer retrieving command (for instance, a user name) coincides with that inputted and stored in advance, when the printer specifying button is depressed (turned ON); and a command responding section to create a printer-retrieving command response to which specific information (for instance, a printer specifying flag) is added, when both the user information, mentioned in the above, coincide with each other, so as to send the printer-retrieving command response back to the user terminal device.

On the other hand, the user terminal device is provided with: a command transmitting section to transmit printer retrieving command, to which the user information is added, to the plurality of printers; a command judging section to receive and parse the printer-retrieving command responses sent back from the plurality of printers, so as to determine whether or not specific information is added to each of the printer-retrieving command responses, or whether or not the specific information is in a predetermined state (for instance, the printer specifying flag is turned ON); and a display controlling section to display only such printers that transmitted the printer-retrieving command responses to each of which the specific information is added or in each of which the specific information is in the predetermined state, or to display the concerned printers in a recognizable manner, when displaying a screen for selecting one of the printers.

### Embodiment 1

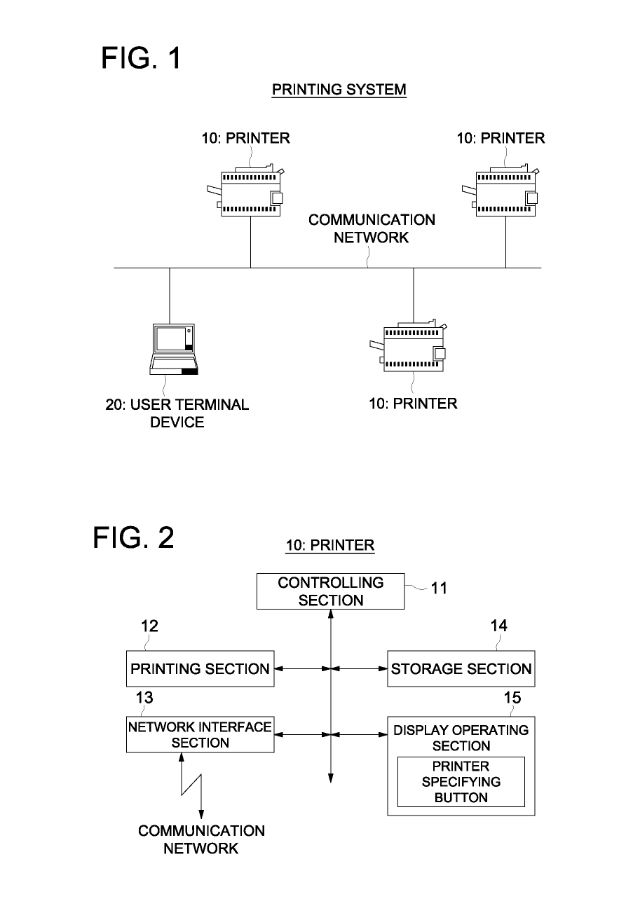

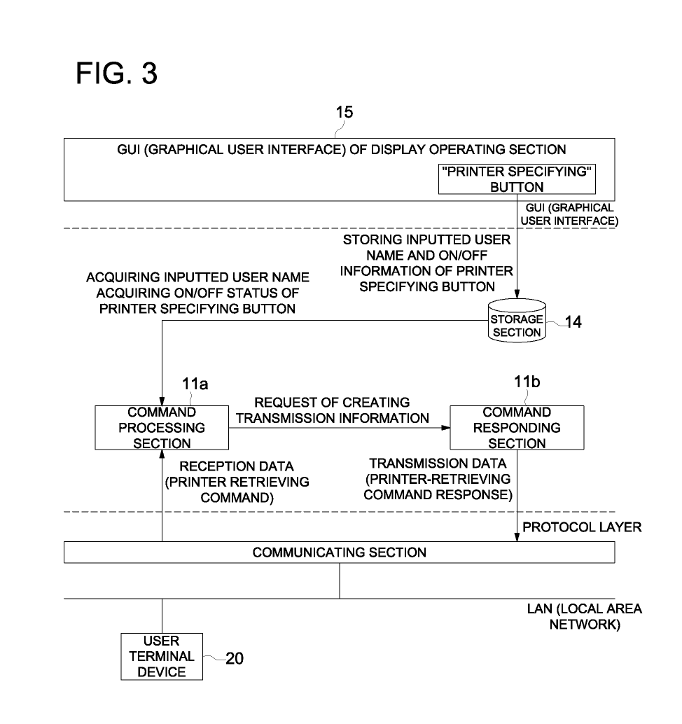

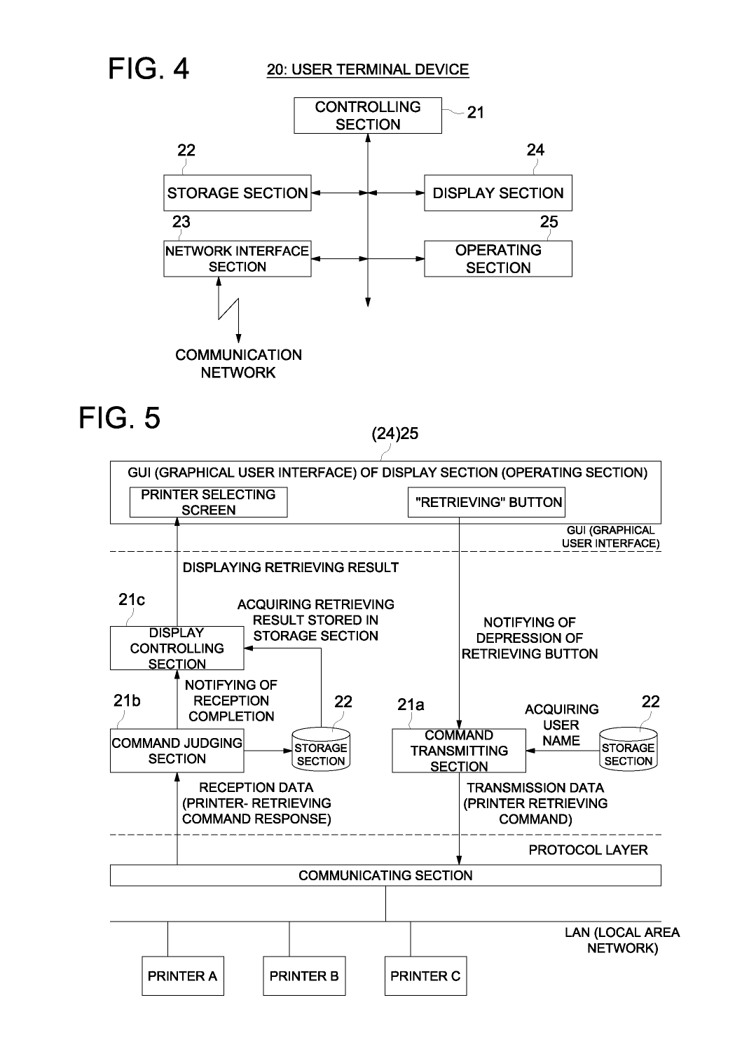

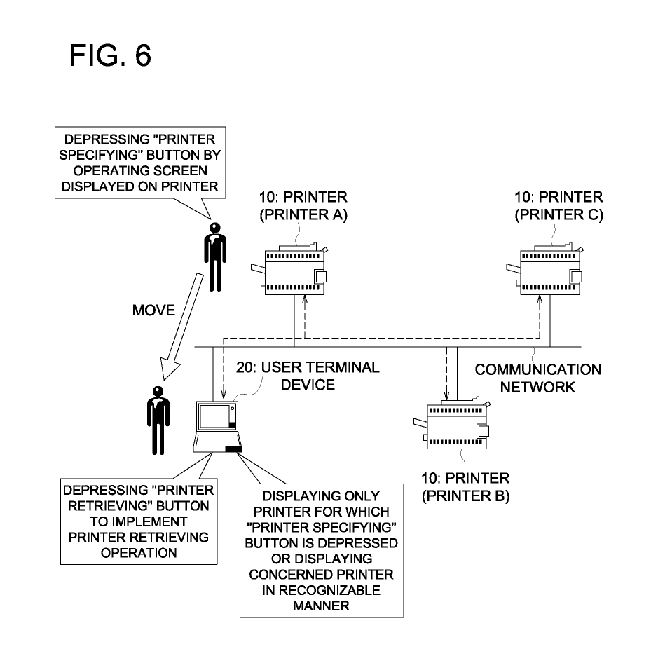

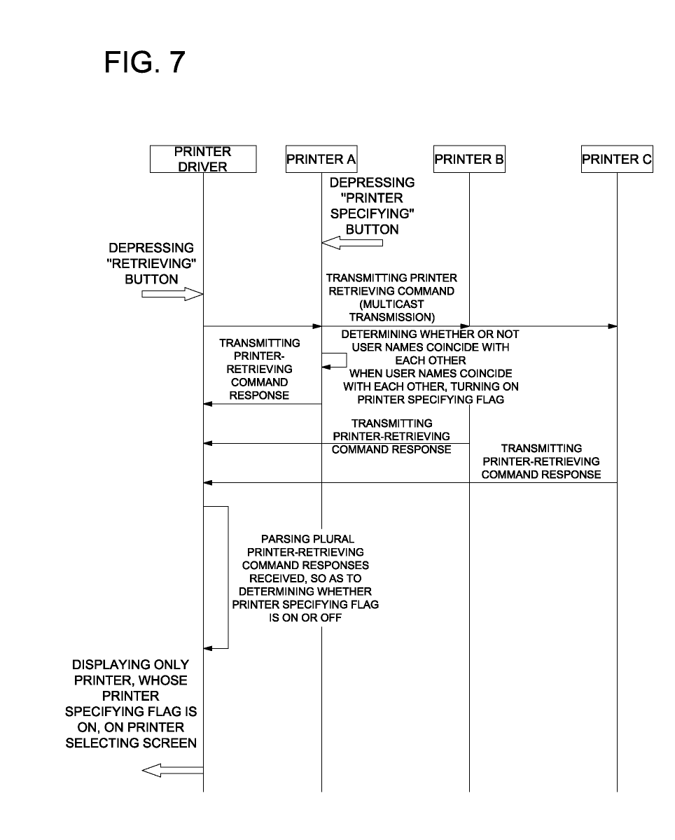

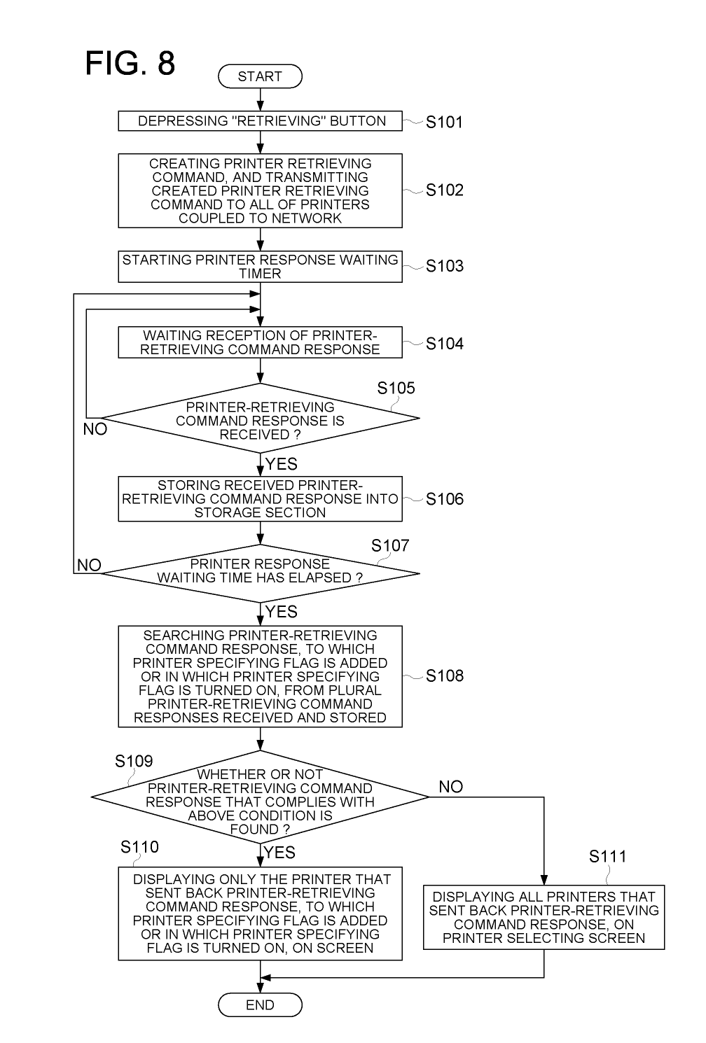

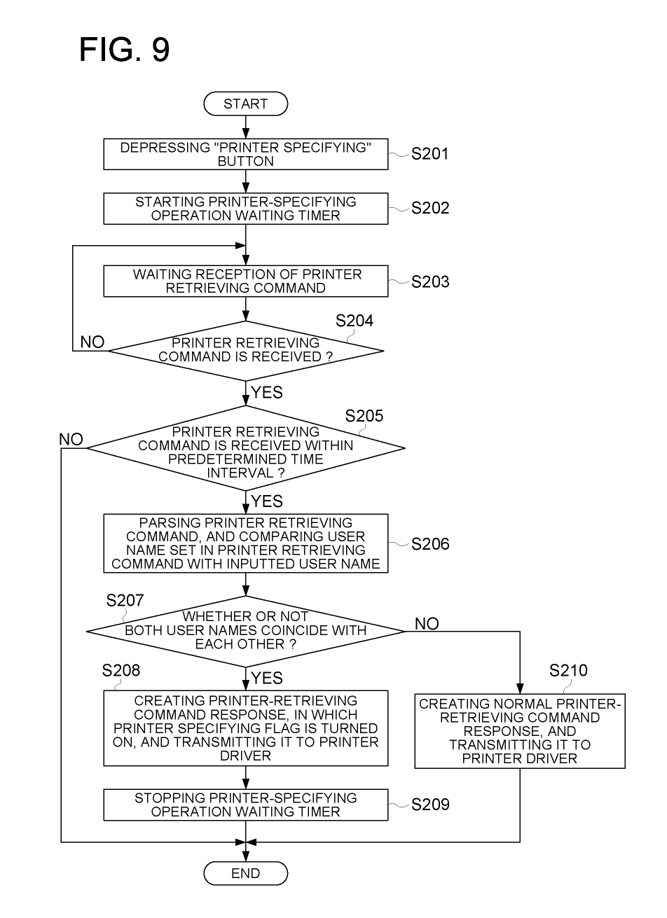

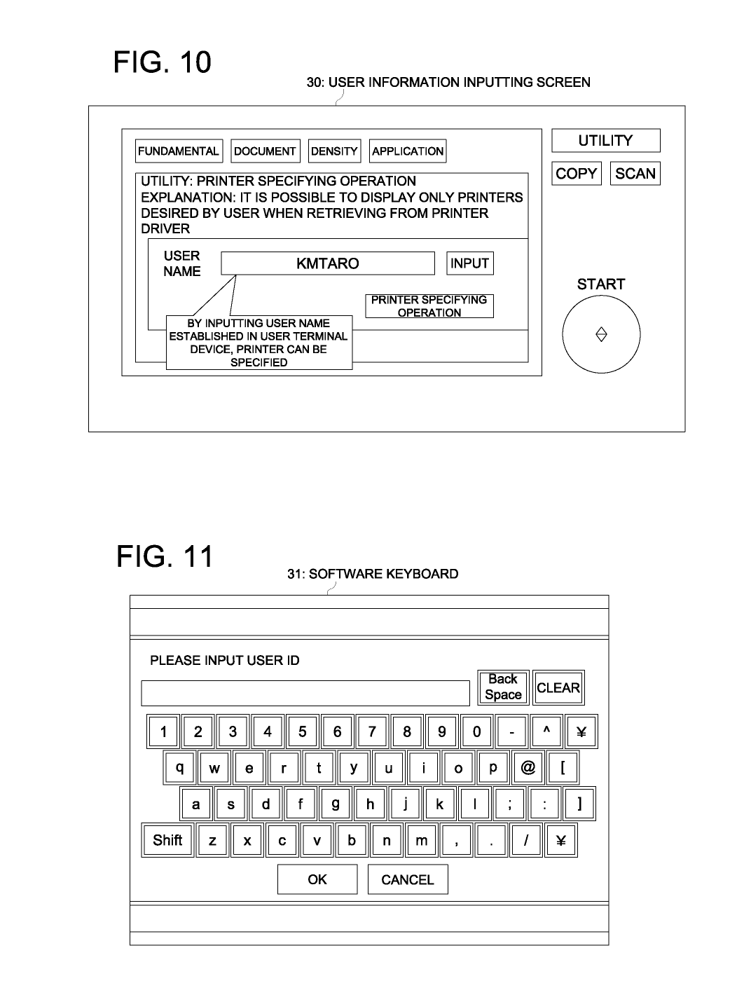

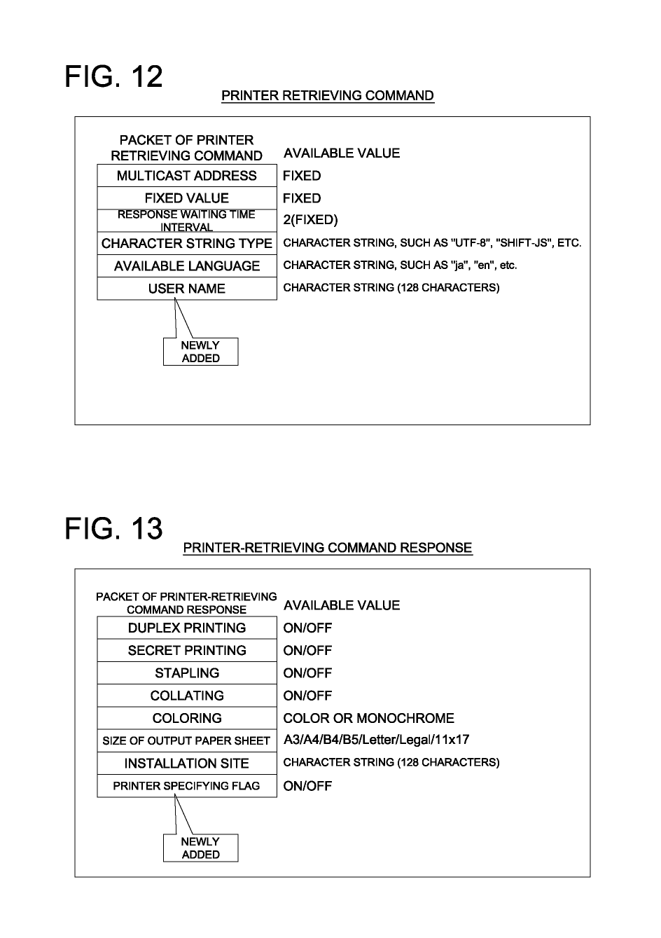

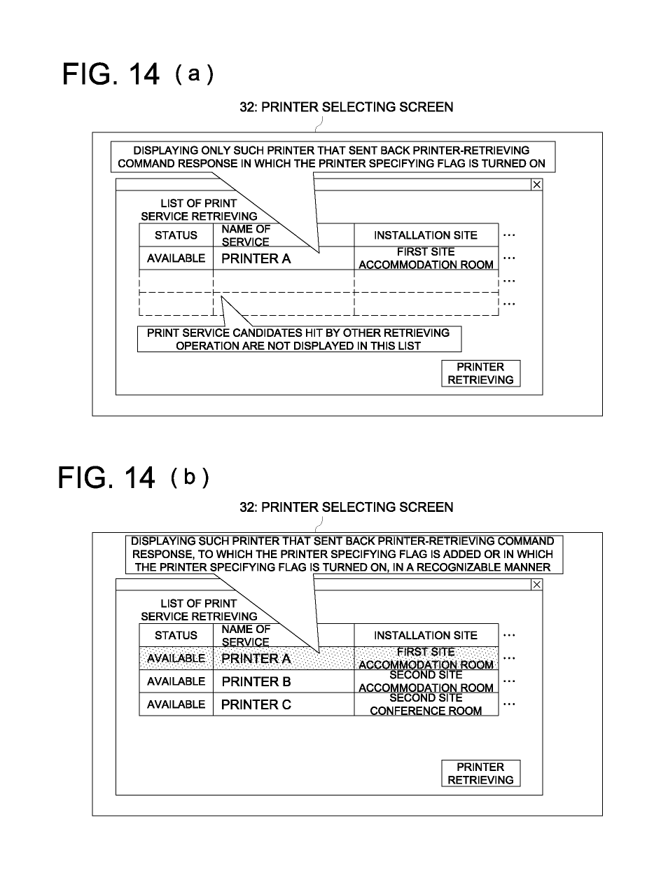

In order to describe the preferred embodiment of the present invention in detail, referring to FIG. 1 through FIG. 14, a printing system and a printer specifying method, embodied in the present invention as EMBODIMENT 1, will be detailed in the following. FIG. 1 shows a schematic diagram of a configuration of the printing system embodied in the present invention. Further, FIG. 2 shows a block diagram indicating a configuration of the printer embodied in the present invention, while FIG. 3 shows a configuration of software of the printer. Still further, FIG. 4 shows a block diagram indicating a configuration of the user terminal device embodied in the present invention, while FIG. 5 shows a configuration of software of the user terminal device. Still further, FIG. 6 shows a schematic diagram briefly indicating operations of the printing system embodied in the present invention, while FIG. 7 shows a schematic diagram indicating an operational flow of the printing system as a whole. Still further, FIG. 8 shows a flowchart indicating detailed operations to be conducted in the user terminal device, while FIG. 9 shows a flowchart indicating detailed operations to be conducted in the printer. Still further, FIG. 10 and FIG. 11 show exemplary layouts of screens to be displayed on the printer, while FIG. 12 and FIG. 13 show exemplary structures of commands to be employed in the printing system embodied in the present invention. Yet further, FIG. 14(a) and FIG. 14(b) show exemplary layouts of screens to be displayed on the user terminal device.

As shown in FIG. 1, the printing system, embodied in the present invention, is constituted by a user terminal device 20 to instruct a printing operation and a plurality of printers 10 (hereinafter, each of the plurality of printers 10 is referred to as a printer 10) to implement the printing operation, which are coupled to each other through a communication network, such as a LAN (Local Area Network), a WAN (Wide Area Network), etc. The printer 10 and the user terminal device 20 will be detailed in the following.

<Printer>

As shown in FIG. 2, the printer 10 in the present embodiment is provided with a controlling section 11, a printing section 12, a network interface section 13, a storage section 14, a display operating section 15, etc., which are coupled to each other through a bus. In this connection, although the printer 10 employed in the present embodiment is provided with only a printing function, the present invention is also applicable for other image forming apparatuses as a whole, such as a copier or a MPF (Multi Function Peripheral), which is also provided with a copy function, a facsimile function, a scanner function, etc., in addition to the printing function.

The controlling section 11 is constituted by a CPU (Central Processing Unit), a ROM (Read Only Memory), a RAM (Random Access Memory), etc. By operating the display operating section 15, the CPU reads out various kinds of programs stored in the ROM so as to develop the programs on the RAM, and controls the each of the sections included in the printer 10 according to the programs developed on the RAM.

The printing section 12 is provided with: an image forming section to form an image to be printed on a transfer paper sheet; an image transferring section to transfer the image formed by the image forming section onto the transfer paper sheet; a fixing section to fix the transferred image onto the transfer paper sheet; a conveyance section to convey the transfer paper sheet; cleaning sections to clean the image forming section, the image transferring section and the fixing section, respectively; etc. Further, the printing section 12 employs the electro-photographic method for forming the image on the transfer paper sheet based on the image data inputted, and outputs the transfer paper sheet on which the image is formed.

The network interface section 13 is constituted by a NIC (Network Interface Card), a modem, a LAN (Local Area Network) adaptor, a router, a TA (Terminal Adapter), etc., so as to conduct controlling operations for communicating with the user terminal device 20 through the communication network.

The storage section 14 is constituted by a flash memory, an HDD (Hard Disc Drive), etc., so as to store various kinds of data, setting conditions, etc., therein. Specifically in the present embodiment, information indicating whether or not a printer specifying button, detailed later, is depressed, user information, such as a user name inputted from the display operating section 15, etc., are also stored in the storage section 14.

The display operating section 15 is formed by mounting a pressure-sensitive operating section (touch panel), in which transparent electrodes are aligned in a lattice pattern, onto a display section, such as a LCD (Liquid Crystal Display), an Organic Electroluminescence Display, etc., so as to make it possible to detect X-Y coordinates of a power point depressed by a finger, a touch pen, etc., as voltage values. The detected positional signals are to be outputted to the controlling section 11 as operational signals. Specifically in the present embodiment, the display operating section 15 is provided with the printer specifying button for specifying its own apparatus when conducting a printer retrieving operation. By depressing the printer specifying button, a user name inputted in advance is stored into the storage section 14. Further, a TRUE/FALSE flag (hereinafter, also referred to as a printer specifying flag) for indicating whether or not the printer specifying button is depressed is also stored in the storage section 14.

Further, as shown in FIG. 3, the controlling section 11 also serves as a command processing section 11a and a command responding section 11b, in addition to serving as the controller to control the various sections included in the printer 10.

The command processing section 11a receives a command for retrieving a specific printer (hereinafter, referred to as a printer retrieving command) sent from the user terminal device 20, so as to parse the printer retrieving command received. Further, the command processing section 11a inquires the storage section 14 to acquire information in regard to the ON/OFF (activation or deactivation) status of the printer specifying function, and acquires the user name stored in the storage section 14 if the printer specifying function is activated (ON status). Then, the command processing section 11a compares the acquired user name with the user name stored in the storage section 14, and notifies the command responding section 11b of a message for urging to transmit the response data for the printer retrieving command (hereinafter, referred to as a printer-retrieving command response) to the user terminal device 20, when the acquired user name and the stored user name coincide with each other.

In response to the abovementioned message, the command responding section 11b creates the printer-retrieving command response to which information indicating the specified printer is attached (for instance, the printer-retrieving command response in which the printer specifying flag is turned ON), and transmits it to the user terminal device 20.

<User Terminal Device>

Further, as shown in FIG. 4, the user terminal device 20 to be employed in the present embodiment is constituted by a controlling section 21, a storage section 22, a network interface section 23, a display section 24, an operating section 25, etc., which are coupled to each other through a bus. In this connection, the user terminal device 20 can be arbitrarily formed in any one of various types, such as a portable-type personal computer, a PDA (Personal Digital Assistants), a mobile telephone or the like, a setting-type personal computer, a printer controller, a server, etc.

The controlling section 21 is constituted by a CPU (Central Processing Unit), a ROM (Read Only Memory), a RAM (Random Access Memory), etc. By operating the operating section 25, the CPU reads out various kinds of programs stored in the ROM so as to develop the programs on the RAM, and controls the each of the sections included in the user terminal device 20 according to the programs developed on the RAM.

The storage section 22 is constituted by a flash memory, an HDD (Hard Disc Drive), etc., so as to store various kinds of data, setting conditions, etc., therein. Specifically in the present embodiment, the user information including the user name, etc. inputted by operating the operating section 25, setting information of the printer retrieving command, etc., are stored in the storage section 22.

The network interface section 23 is constituted by a NIC (Network Interface Card), a modem, a LAN (Local Area Network) adaptor, a router, a TA (Terminal Adapter), etc., so as to conduct controlling operations for communicating with the printer 10 through the communication network.

The display section 24 is constituted by a LCD (Liquid Crystal Display), an Organic Electroluminescence Display, etc., so as to display a screen for instructing the printing operation, a screen for selecting a printer, etc., thereon. Further, the operating section 25 is constituted by a keyboard, a mouse, etc., so as to make operations for inputting user information, selecting the printer 10, etc., possible. Specifically in the present embodiment, the display section 24 is provided with the retrieving button for instructing the printer retrieving operation. By depressing the retrieving button, the printer retrieving command is transmitted. In this connection, it is applicable that the display section 24 and the operating section 25 are either equipped separately from each other, or integrally mounted as a combined touch panel.

Further, as shown in FIG. 5, the controlling section 21 also serves as a predetermined printer driver for instructing the printer 10 on the printing operation, in addition to serving as the controller to control the various sections included in the user terminal device 20. While, the printer driver also serves as a command transmitting section 21a, a command judging section 21b and a display controlling section 21c, in addition to the normal functions such, as the setting operation of the print conditions, etc.

The command transmitting section 21a creates and transmits the printer retrieving command. At that time, the command transmitting section 21a acquires the user name concerned, and sets the acquired user name into the printer retrieving command.

The command judging section 21b receives the printer-retrieving command response within a constant time interval, and parses the printer-retrieving command response received, and then, stores the retrieving result, acquired by retrieving printers based on the printer-retrieving command response, into the storage section 22. Further, after the constant time interval, serving as a reception waiting time, has elapsed, the command judging section 21b notifies the display controlling section 21c of the reception completing notice.

Acquiring the retrieving result from the storage section 22, the display controlling section 21c creates various character strings, etc., which are to be displayed in the printer selecting screen. At that time, if the printer specifying flag is attached to the printer-retrieving command response concerned, or if there exists a printer whose printer specifying flag is turned ON, the display controlling section 21c displays only the printer concerned, or displays the screen in such a manner that the printer concerned is distinguishable (or recognizable) from other printers displayed on the same screen. Otherwise, if the printer specifying flag is not attached to the printer-retrieving command response concerned, or if there exists no printer whose printer specifying flag is turned ON, the display controlling section 21c displays all of the printers, included in the retrieving result stored in the storage section 22.

Next, referring to FIG. 6, brief operations to be conducted in the abovementioned printing system will be detailed in the following.

At first, the user goes to a desired printer 10 in advance, to depress the “PRINTER SPECIFYING” button by operating the screen displayed on the display operating section 15 (refer to (1)). Successively, the user returns to his own user terminal device 20, so as to make the user terminal device 20 execute the printer driver, and then, depress the “PRINTER RETRIEVING” button (refer to (2)). Still successively, as detailed later, the communication signals of the printer retrieving command and the printer-retrieving command response are exchanged between the user terminal device 20 and the printer 10, in order to display the printer desired by the user, on the printer selecting screen to be displayed on the user terminal device 20, in such a manner that only the desired printer emerges on the screen, or the desired printer concerned is distinguishable (or recognizable) from the other printers displayed within the same screen (refer to (3)).

Next, referring to FIG. 7 through FIG. 9, the detailed operations to be conducted in the printing system will be detailed in the following.

Proceeding to the specifying operation of the printer 10, the user goes to a desired printer 10 (herein, being a printer A shown in FIG. 7), to operate the display operating section 15 so as to make it display a user information inputting screen 30, shown in FIG. 10, thereon, and then, to input the user name. The user information inputting screen 30 includes a user name inputting field to input the user name for specifying the user, an “INPUT” button to display a software keyboard 31 for inputting the user name as shown in FIG. 11, the “PRINTER SPECIFYING” button, serving as an input interface for attaching the printer specifying flag to the printer retrieving command received, etc. The user inputs the user name established in advance in the user terminal device 20 into the user name inputting field.

Successively, in the printer 10, when the user depresses the “PRINTER SPECIFYING” button (Step S201), the ON status of the printer specifying function is stored in the storage section 14. Then, the controlling section 11 starts the printer-specifying operation waiting timer (Step S202), so as to wait a reception of the printer retrieving command to be sent from the user terminal device 20, until the waiting time interval set in the timer has elapsed (becomes timeout) (Step S203 through Step S205).

Still successively, returning to the user terminal device 20, the user depresses the “RETRIEVING” button disposed at the operating section 25 (Step S101). Then, the command transmitting section 21a of the user terminal device 20 acquires the user name established in advance from the storage section 22 to set the user name into the printer retrieving command, and transmits the concerned printer retrieving command to all of the printers 10 coupled to the network (Step S102). Although the structure of the printer retrieving command is not limited to a specific one, a structure in which the user name is added (or attached) to the conventional printer retrieving command is applicable in the present invention, for instance, as shown in FIG. 12. Further, although it is desirable that the printer retrieving command is transmitted to all of the printers 10 in the system at a time (Multicast Transmission), even if the system is so constituted that the printer retrieving command is sequentially transmitted one by one to each of the printers 10, since it is unnecessary to confirm the return response to be sent back from each of the printers 10 as set forth in Tokkai 2006-236176 (Japanese Non-Examined Patent Publication), it is possible to transmit the printer retrieving command to all of the printers 10 within a short time interval.

Still successively, the controlling section 21 starts the printer response waiting timer (Step S103), so as to wait a reception of the printer-retrieving command response to be sent from the printer 10, until the waiting time interval, set in the timer, has elapsed (Step S104 through Step S107).

When the printer 10 has not received the printer retrieving command sent from the user terminal device 20 within the predetermined time interval (Step S205; No), the printer 10 jumps to END, so as to finalize the processing. On the other hand, when the printer 10 has received the printer retrieving command (Step S205; Yes), the command processing section 11a parses the printer retrieving command so as to acquire the user name set in the printer retrieving command (Step S206). Further, the command processing section 11a inquires the storage section 14 about whether the status of the printer specifying function is ON or OFF. When the status of the printer specifying function is ON, the command processing section 11a acquires the user name, inputted in advance by using the user information inputting screen 30, from the storage section 14 (Step S206).

Still successively, the command processing section 11a compares the user name acquired from the printer retrieving command with that acquired from the storage section 14 (Step S206). When determining that both the user names coincide with each other (Step S207; Yes), the command responding section 11b creates the printer-retrieving command response, in which the printer specifying flag is turned ON, so as to transmit the created printer-retrieving command response to the user terminal device 20 (herein, the printer A shown in FIG. 7 transmits the response concerned) (Step S208), and then, the controlling section 11 stops the printer-specifying operation waiting timer (Step S209). Although the structure of the printer retrieving command response is not limited to a specific one, a structure in which the printer specifying flag is added (or attached) to the conventional printer-retrieving command response is applicable in the present invention, for instance, as shown in FIG. 13.

On the other hand, when determining that the user name set in the printer retrieving command does not coincide with the other user name inputted in advance by using the user information inputting screen 30 (Step S207; No), the command responding section 11b creates the normal printer-retrieving command response (for instance, a printer-retrieving command response from which the printer specifying flag is excluded, or another printer-retrieving command response in which the printer specifying flag is turned OFF), so as to transmit the created printer-retrieving command response to the user terminal device 20 (herein, the printer B and the printer C shown in FIG. 7 transmit the response concerned) (Step S210).

Still successively, when the user terminal device 20 receives the printer-retrieving command response within a predetermined time interval, the user terminal device 20 sequentially stores the received printer-retrieving command response into the storage section 22 (Step S106). When the waiting time interval, set in the printer response waiting timer, has elapsed, the command judging section 21b searches a printer-retrieving command response, to which the printer specifying flag is added or in which the printer specifying flag is turned ON, from the plurality of printer-retrieving command responses received and stored in the storage section 22 (Step S108).

Yet successively, if a printer-retrieving command response, to which the printer specifying flag is added or in which the printer specifying flag is turned ON, is found (Step S109; Yes), the display controlling section 21c controls the display section 24 to display only the printer that sent back the abovementioned printer-retrieving command response, when making the display section 24 display a printer selecting screen 32 thereon, as shown in FIG. 14(a), (Step S110). In this connection, it is also applicable that any one of various kinds of display modes, such as a color changing display mode, a flashing display mode, an emphasizing display mode, etc., is employed for displaying a specific line indicating information of the printer concerned in the printer selecting screen 32, as shown in FIG. 14(b), as far as the user can recognize (or distinguish) the printer that sent back the printer-retrieving command response to which the printer specifying flag is added or in which the printer specifying flag is turned ON.

On the other hand, if a printer-retrieving command response, to which the printer specifying flag is added or in which the printer specifying flag is turned ON, is not found (Step S109; No), the display controlling section 21c controls the display section 24 to display a list of all printers 10 that sent back the printer-retrieving command response, on the printer selecting screen 32 (Step S111).

As described in the foregoing, initially, the user terminal device 20 transmits the printer retrieving command, into which the user name is set, to the printer 10. Receiving the printer retrieving command, the printer 10 sends the printer-retrieving command response, to which the printer specifying flag is added or in which the printer specifying flag is turned ON, back to the user terminal device 20, when determining that the printer specifying function is turned ON and both the user names coincide with each other. Receiving the printer-retrieving command response, the user terminal device 20 displays only such the printer that transmitted the printer-retrieving command response, to which the printer specifying flag is added or in which the printer specifying flag is turned ON, or to display the concerned printer in a recognizable manner, when displaying the printer selecting screen. Accordingly, it becomes possible to easily and securely specify the printer 10 desired by the user. As a result, it becomes possible to eliminate such an error that printouts are outputted from a wrong printer unintended by the user, resulting in an improvement of the security aspect of the printing system.

### Embodiment 2

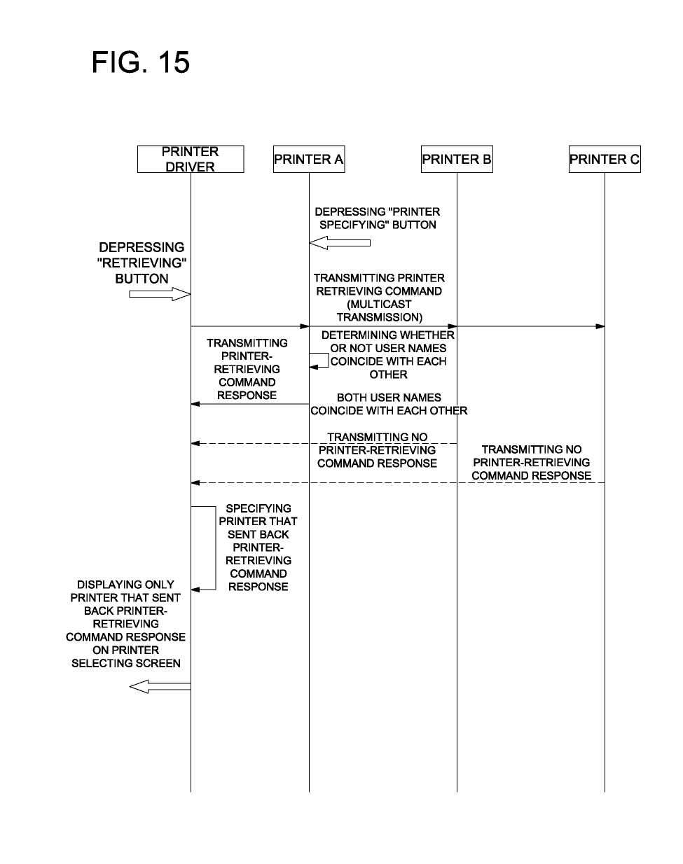

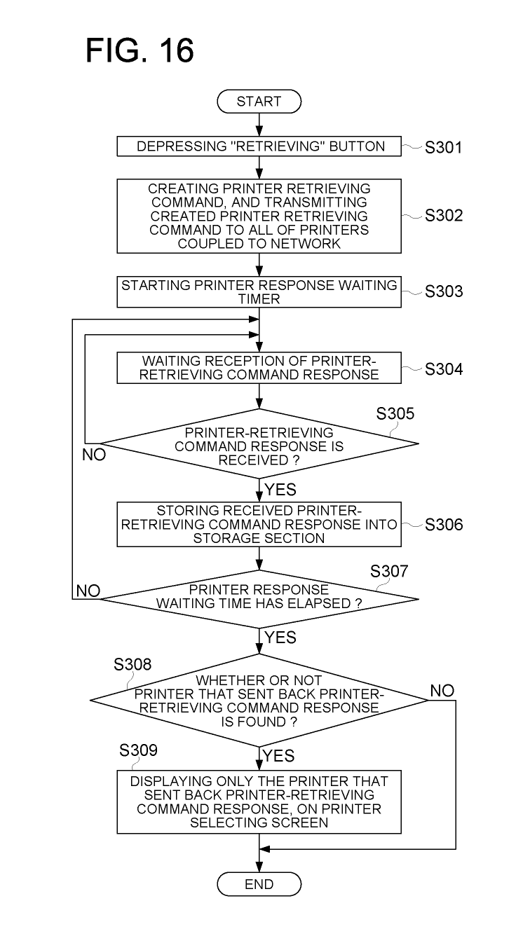

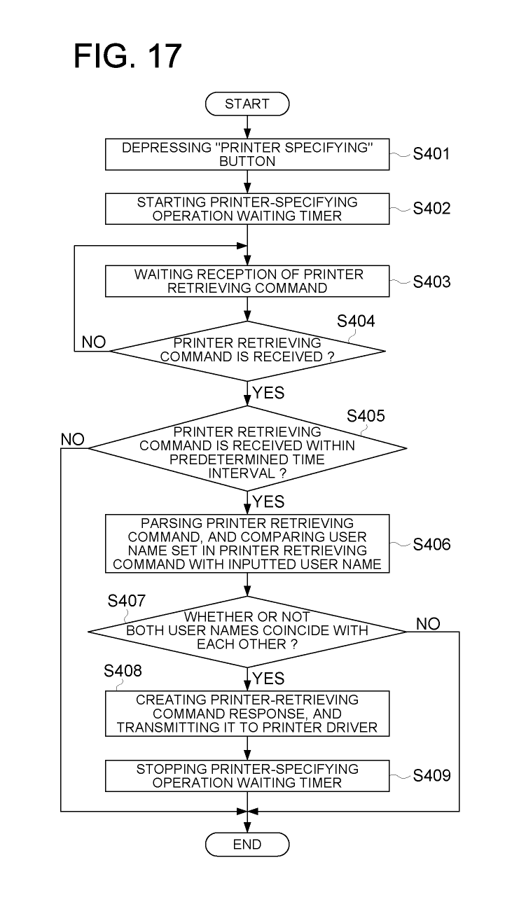

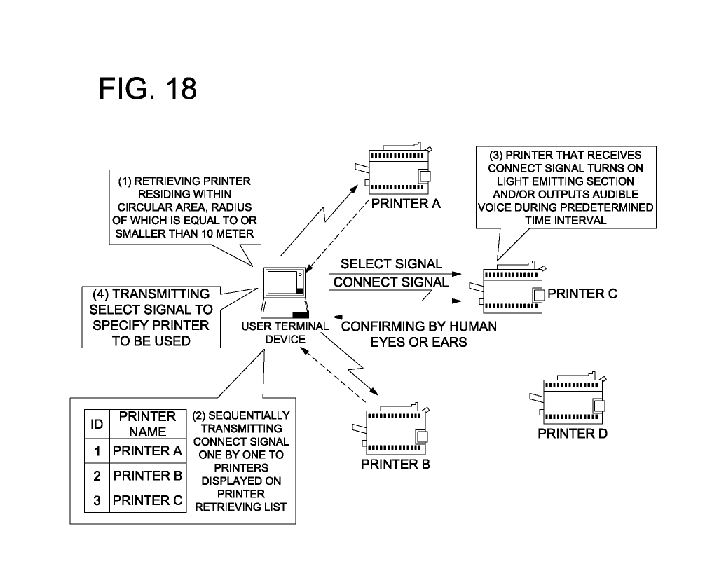

Next, referring to FIG. 15 through FIG. 17, a printing system and a printer specifying method, embodied in the present invention as EMBODIMENT 2, will be detailed in the following. FIG. 15 shows a schematic diagram indicating an operational flow of the printing system as a whole. Further, FIG. 16 shows a flowchart indicating detailed operations to be conducted in the user terminal device, while FIG. 17 shows a flowchart indicating detailed operations to be conducted in the printer.

In EMBODIMENT 1 described in the foregoing, it is premised that the printer 10 sends the printer-retrieving command response back to the user terminal device 20, when the printer 10 receives the printer retrieving command, and the system is so constituted that the user terminal device 20 displays only such the printer that sent the printer-retrieving command response, to which the printer specifying flag is added or in which the printer specifying flag is turned ON, back to the user terminal device 20, or to display the concerned printer in a recognizable manner, when displaying the printer selecting screen. However, it is also applicable that this printer-retrieving command response is sent back to the user terminal device 20 as needed.

Accordingly, EMBODIMENT 2 is so constituted that the operation for displaying the printer selecting screen is controlled on the basis of the decision for whether or not the printer-retrieving command response is sent back to the user terminal device 20, instead of that for whether or not the printer specifying flag is added to printer-retrieving command response or whether the printer specifying flag is turned ON or OFF.

In the abovementioned EMBODIMENT 2, although the fundamental configurations of the printer 10 and the user terminal device 20 are the same as those in the aforementioned EMBODIMENT 1, the command responding section 11b of the printer 10 conducts controlling operations for sending the printer-retrieving command response back to the user terminal device 20, only when the user name attached to the printer retrieving command coincides with that stored in the storage section 14. Further, the command judging section 21b of the user terminal device 20 stores the printer-retrieving command response into the storage section 22 as it is without parsing it, while the display controlling section 21c acquires the retrieving result from the storage section 22 so as to conduct controlling operations for displaying only the printer that sent the printer-retrieving command response back to the user terminal device 20.

Referring to FIG. 15 through FIG. 17, the operations to be conducted in the printing system, having the abovementioned configuration, will be detailed in the following.

At first, as well as EMBODIMENT 1, the user goes to a desired printer 10 (herein, printer A shown in FIG. 15) to make the printer 10 display the user information inputting screen 30, and then, inputs the user name.

Successively, in the printer 10, when the user depresses the “PRINTER SPECIFYING” button (Step S401), the ON status of the printer specifying function is stored in the storage section 14. Then, the controlling section 11 starts the printer-specifying operation waiting timer (Step S402), so as to wait a reception of the printer retrieving command to be sent from the user terminal device 20, until the waiting time interval set in the timer has elapsed (becomes timeout) (Step S403 through Step S405).

Still successively, returning to the user terminal device 20, the user depresses the “RETRIEVING” button disposed at the operating section 25 (Step S301). Then, the command transmitting section 21a of the user terminal device 20 acquires the user name established in advance from the storage section 22 to set the user name into the printer retrieving command, and transmits the concerned printer retrieving command to all of the printers 10 coupled to the network.

Still successively, the controlling section 21 starts the printer response waiting timer (Step S303), so as to wait a reception of the printer-retrieving command response to be sent from the printer 10, until the waiting time interval, set in the timer, has elapsed (Step S304 through Step S307).

When the printer 10 has not received the printer retrieving command sent from the user terminal device 20 within the predetermined time interval (Step S405; No), the printer 10 jumps to END, so as to finalize the processing. On the other hand, when the printer 10 has received the printer retrieving command (Step S405; Yes), the command processing section 11a parses the printer retrieving command so as to acquire the user name set in the printer retrieving command (Step S406). Further, the command processing section 11a inquires the storage section 14 about whether the status of the printer specifying function is ON or OFF. When the status of the printer specifying function is ON, the command processing section 11a acquires the inputted user name from the storage section 14 (Step S406).

Still successively, the command processing section 11a compares the user name acquired from the printer retrieving command with that acquired from the storage section 14 (Step S206). When determining that both the user names do not coincide with each other (Step S407; No), the command processing section 11a finalize the processing (END). When determining that both the user names coincide with each other (Step S407; Yes), the command responding section 11b creates the printer-retrieving command response, so as to transmit the created printer-retrieving command response to the user terminal device 20 (herein, only the printer A, shown in FIG. 15, transmits the response concerned) (Step S408), and then, the controlling section 11 stops the printer-specifying operation waiting timer (Step S409).

Still successively, when the user terminal device 20 receives the printer-retrieving command response within a predetermined time interval, the user terminal device 20 sequentially stores the received printer-retrieving command response into the storage section 22 (Step S306). When the waiting time interval, set in the printer response waiting timer, has elapsed, the command judging section 21b determines whether or not the printer, which sent the printer-retrieving command response back to the user terminal device 20 concerned, exists (Step S308).

Yet successively, when determining that the printer, which sent back the printer-retrieving command response, does not exist (Step S308; No), the user terminal device 20 finalizes the processing (END). While, when determining that the printer, which sent back the printer-retrieving command response, exists (Step S308; Yes), the display controlling section 21c controls the display section 24 to display only the printer, which sent back the printer-retrieving command response, when making the display section 24 display a printer selecting screen 32 thereon.

As described in the foregoing, initially, the user terminal device 20 transmits the printer retrieving command, into which the user name is set, to the printer 10. Receiving the printer retrieving command, the printer 10 sends the printer-retrieving command response back to the user terminal device 20, when determining that the printer specifying function is turned ON and both the user names coincide with each other. Receiving the printer-retrieving command response, the user terminal device 20 displays only such the printer that sent back the printer-retrieving command response. Accordingly, it becomes possible to easily and securely specify the printer 10 desired by the user. As a result, it becomes possible to eliminate such an error that printouts are outputted from a wrong printer unintended by the user, resulting in an improvement of the security aspect of the printing system.

In this connection, although the user terminal device 20 instructs the printer on the printing operation in each of the systems of embodiment 1 and embodiment 2, the scope of the present invention is not limited to embodiment 1 and embodiment 2. For instance, the present invention is also applicable for such the case that the user terminal device transmits print data, etc., to a desired image forming apparatus so as to make the desired image forming apparatus store the transmitted print data, etc., therein, or the like, as well.

The present invention is available for: an image forming apparatus provided with a printing function; a printing system, which includes the abovementioned image forming apparatus; and a printer specifying method to be employed in the abovementioned printing system.

According to the printing system and the printer specifying method, embodied in the present invention, even in an environment in which a plurality of printers are coupled to each other through a network, it becomes possible to easily and securely specify a specific printer desired by the user. As a result, even when a document including secret information is to be printed, it becomes possible to prevent the secret information from leaking, resulting in an improvement of the security aspect of the printing system.

While the preferred embodiments of the present invention have been described using specific term, such description is for illustrative purpose only, and it is to be understood that changes and variations may be made without departing from the spirit and scope of the appended claims.

What is claimed is:

1. A printing system, comprising:
a plurality of printers to implement a printing operation; and
a user terminal device, coupled to the plurality of printers through a communication network, to instruct at least one of the plurality of printers to implement the printing operation;
wherein the user terminal device is provided with:
a command transmitting section that creates a command to which user information is added, the command being for retrieving printers, and transmits the command to the plurality of printers through the communication network;
a command judging section that receives responses to the command sent back from the plurality of printers, and determines whether or not specific information is attached to each of the responses; and
a display controlling section that controls a display section to display on a printer selecting screen only the specific printer that transmits the response to which the specific information is attached, or to display on the printer selecting screen all of the plurality of printers that sent back the responses among which the specific printer is recognizable; and
wherein each of the plurality of printers is provided with:
an instruction button;
a command processing section that receives the command sent from the user terminal device, and determines whether or not the user information added to the command coincides with user information stored in advance, when the instruction button is depressed; and
a command responding section that creates the response by attaching the specific information to the response to the printer retrieving command, and transmits the response to the user terminal device, when the command processing section determines that the user information added to the command coincides with the stored user information.

2. The printing system of claim 1,
wherein, when the command judging section of the user terminal device determines that none of the plurality of printers sent back the response to which the specific information is attached, the display controlling section controls the display section to display all of printers that sent back the responses.

3. A printing system, comprising:
a plurality of printers to implement a printing operation; and
a user terminal device, coupled to the plurality of printers through a communication network, to instruct at least one of the plurality of printers to implement the printing operation;
wherein the user terminal device is provided with:
a command transmitting section that creates a command to which user information is added, and transmits the command to the plurality of printers through the communication network, wherein the command is for retrieving a specific printer among the plurality of printers;
a command judging section that receives a response to the command sent back from one of the plurality of printers; and
a display controlling section that controls a display section to display on a printer selection screen only the specific printer that transmits the response; and
wherein each of the plurality of printers is provided with:
an instruction button;
a command processing section that receives the command sent from the user terminal device, and determines whether or not the user information added to the printer retrieving command coincides with user information stored in advance, when the instruction button is depressed; and
a command responding section that transmits the response to the user terminal device, only when the command processing section determines that the user information added to the command coincides with the stored user information.

4. A printer specifying method to be implemented in a printing system that includes: a plurality of printers to implement a printing operation; and a user terminal device, coupled to the plurality of printers through a communication network, to instruct at least one of the plurality of printers to implement the printing operation, the printer specifying method comprising:
the user terminal device creating a command to which user information is added, the command being for retrieving printers;
the user terminal device transmitting the command to the plurality of printers through the communication network;
each of the plurality of printers receiving the command sent from the user terminal device, and then, determining whether or not the user information added to the command coincides with user information stored in advance, when an instruction button is depressed;
each of the plurality of printers creating a response to the command sent from the user terminal device, and then, transmitting the response back to the user terminal device, wherein the specific information is added to the response when the command processing section determines that the user information added to the command coincides with the stored user information;
the user terminal device receiving the responses sent back from the plurality of printers, and then, determining whether or not specific information is attached to each of the responses; and
the user terminal device controlling a display section to display on a printer selecting screen only the specific printer that transmits the response to which the specific information is attached, or to on the printer selecting screen display all of the plurality of printers that sent back the responses among which the specific printer is recognizable.

5. The printer specifying method of claim 4,
wherein, when it is determined that none of the plurality of printers sent back response to which the specific information is attached, the display section is controlled so as to display all of printers that sent back the printer-retrieving command response.

6. A printer specifying method to be implemented in a printing system that includes: a plurality of printers to implement a printing operation; and a user terminal device, coupled to the plurality of printers through a communication network, to instruct at least one of the plurality of printers to implement the printing operation, the printer specifying method comprising:
the user terminal device creating a command to which user information is added, the command being for retrieving a specific printer;
the user terminal device transmitting the command to the plurality of printers through the communication network;
each of the plurality of printers receiving the command from the user terminal device, and then, determining whether or not the user information added to the printer retrieving command coincides with user information stored in advance, when an instruction button is depressed;
each of the plurality of printers transmitting a response to the command sent from the user terminal device, only when it is determined that the user information added to the command coincides with the stored user information;
the user terminal device receiving the response sent back from one of the plurality of printers; and
the user terminal device controlling a display section to display on a printer selecting screen only the specific printer that transmits the response.
